(19) United States
(12) Patent Application Publication
(10) Pub. No.: US 2018/0309744 A1
(43) Pub. Date: Oct. 25, 2018

(54) STORAGE DEVICE AND OPERATION METHOD OF THE SAME

(71) Applicant: Hung-Chien CHOU, Taichung City (TW)

(72) Inventor: Hung-Chien CHOU, Taichung City (TW)

(21) Appl. No.: 15/956,686

(22) Filed: Apr. 18, 2018

(30) Foreign Application Priority Data
Apr. 20, 2017 (TW) 106113276

(51) Int. Cl. H04L 29/06; G06F 21/31; G06F 21/60

(52) U.S. Cl. CPC H04L 63/083; G06F 21/31; G06F 21/62; G06F 21/602; H04L 63/10

(57) ABSTRACT

An operation method of a storage device includes: obtaining a user-input password based on input password data received from an electronic device over a preset communication network; when the user-input password matches an access password pre-stored in the storage device, transmitting to the electronic device over the preset communication network a verification code and login information that is pre-stored in the storage device for accessing the storage device over a private communication network; and when an access code received from the electronic device over the private communication network matches the verification code, allowing the electronic device to access a classified storage region over the private communication network.

### CROSS-REFERENCE TO RELATED APPLICATION

This application claims priority to Taiwanese Patent Application No. 106113276 filed on Apr. 20, 2017.

### FIELD

The disclosure relates to a storage device and an operation method of the storage device, and more particularly to a storage device and an operation method for prohibiting unauthorized access to the storage device.

### BACKGROUND

Data stored in a hard disk may be leaked since the hard disk may be lost, stolen, discarded or hacked, and may even be stolen maliciously when the hard disk is serviced by other people. A conventional solution for preventing data leakage is to perform disk encryption on the hard disk using disk encryption software, so that a user can set a password for encrypting and decrypting data stored in the hard disk. By this way, the hard disk can be accessed only by the user who has the password. However, a hacker may obtain such password, e.g., by implanting a malware on the hard disk, and thus access data stored in the hard disk.

### SUMMARY

Therefore, an object of the disclosure is to provide a storage device and an operation method for preventing data leakage.

According to one aspect of the disclosure, a storage device is provided. The storage includes a first communication module, a second communication module, a storage module, and a processing module. The first communication module is configured to be communicatively connected to an electronic device over a preset communication network. The second communication module is configured to provide a private communication network. The storage module stores an access password, and login information that is for accessing the second communication module over the private communication network. The storage module includes a classified storage region. The processing module is electrically connected to the first communicating module, the second communicating module and the storage module.

The processing module is programmed to:
in response to receipt of input password data from the electronic device via the first communication module over the preset communication network, obtain a user-input password based on the input password data, and determine whether the user-input password matches the access password,
when determining that the user-input password matches the access password, generate a verification code, access the login information stored in the storage module, and control the first communication module to transmit the verification code and the login information to the electronic device via the first communication module over the preset communication network, so that the electronic device communicatively connects the second communication module over the private communication network based on the login information,
in response to receipt of an access code from the electronic device through the second communication module over the private communication network, determine whether the access code matches the verification code, and
when determining that the access code matches the verification code, allow the electronic device to access the classified storage region of the storage module via the second communication module over the private communication network.

According to another aspect of this disclosure, an operation method of a storage device is provided. The storage device is communicatively connected to the electronic device over a preset communication network, provides a private communication network, and includes a processing module and a classified storing region. The operation method is to be implemented by the processing module and includes:

in response to receipt of input password data from the electronic device over the preset communication network, obtaining a user-input password based on the input password data;
determining whether the user-input password matches an access password that is pre-stored in the storage device;
when determining that the user-input password matches the access password, generating a verification code, accessing login information that is for accessing the storage device over the private communication network, and transmitting the verification code and the login information to the electronic device over the preset communication network, so that the electronic device is communicatively connected to the storage device over the private communication network based on the login information;
in response to receipt of an access code from the electronic device over the private communication network, determining whether the access code matches the verification code; and

when determining that the access code matches the verification code, allowing the electronic device to access the classified storage region over the private communication network.

### BRIEF DESCRIPTION OF THE DRAWINGS

Other features and advantages of the disclosure will become apparent in the following detailed description of the embodiments with reference to the accompanying drawings, of which:

FIG. 1 is a schematic block diagram of a storage device communicating with an electronic device according to one embodiment of this disclosure; and

FIG. 2 is a flow chart of an operation method of the storage device according to one embodiment of this disclosure.

### DETAILED DESCRIPTION

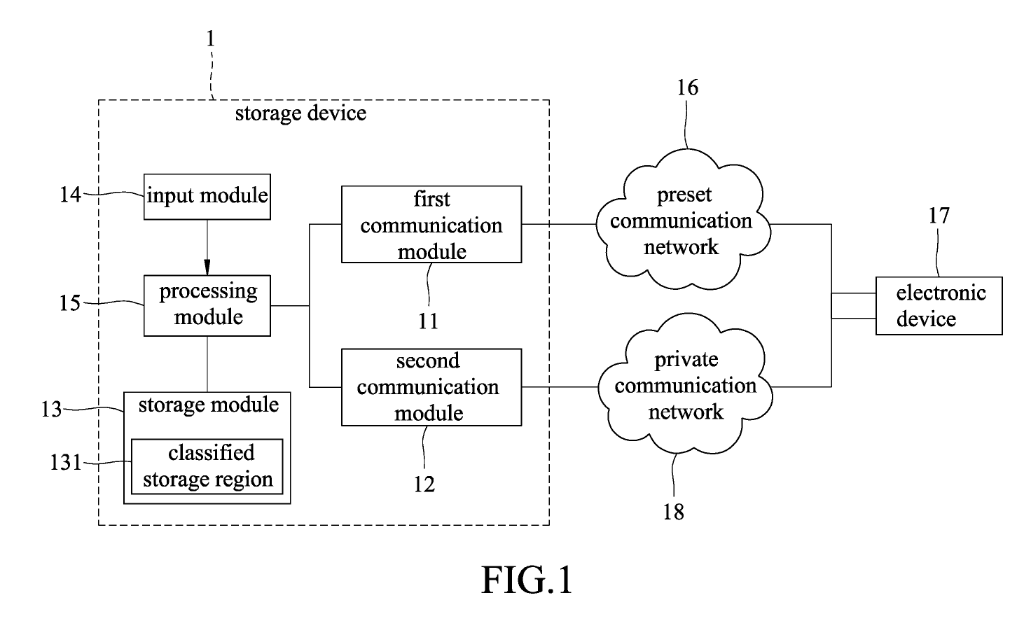

Referring to FIG. 1, a storage device 1 according to one embodiment of this disclosure includes a first communication module 11, a second communication module 12, a storage module 13, an input module 14 and a processing module 15. For example, the storage device 1 is a server, a hard disk drive, or a USB flash drive, etc.

The first communication module 11 is configured to be communicatively connected to an electronic device 17 over a preset communication network 16. In this embodiment, the first communication module 11 is a Bluetooth communication module, and the preset communication network 16 is a short-range wireless network using Bluetooth transmission technology.

The second communication module 12 is configured to provide a private communication network 18. In this embodiment, the second communication module 12 is a Wi-Fi communication module (e.g., an access point, or a Wi-Fi router), and the private communication network 18 is a short-range wireless network, such as a wireless local area network using Wi-Fi transmission technology. The electronic device 17 is, e.g., a smartphone, a tablet, a notebook computer or a desktop computer equipped with a Bluetooth dongle and a Wi-Fi adapter.

The storage module 13 stores an access password and login information, and includes a classified storage region 131. The login information is for accessing the second communication module 12 over the private communication network 18. In this embodiment, the login information includes a service set identifier (SSID) identifying the private communication network 18, and a login password. For example, the storage module 13 may include any non-transitory memory mechanism, such as read-only memory (ROM), random-access memory (RAM), magnetic disk storage media, optical storage media, flash memory, solid state devices (SSD), and other storage devices and media.

The input module 14 is electrically connected to the processing module 15, and is configured to output a trigger signal to the processing module 15 in response to a user operation. For example, the input module 14 is a button that is mounted on the storage device 1, and that can be pressed by a user of the electronic device 17 who intends to use the electronic device 17 to access the classified storage region 131, to thereby output the trigger signal.

The processing module 15 is electrically connected to the first communicating module 11, the second communicating module 12 and the storage module 13. The processing module 15 is programmed to allow or prohibit access to the classified storage region 131. Specifically, the processing module 15 prohibits access to the classified storage region 131 when the storage device 1 is initially powered up. The term “processing module” may refer to any device or portion of a device that processes electronic data from registers and/or memory to transform that electronic data into other electronic data. For example, the processing module 15 is, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc. Note that, in this embodiment, the storage device 1 further includes a universal serial bus (USB) (not shown) through which the electronic device 17 accesses the classified storage region 131. The detail of how the processing module 15 allows access to the classified storage region 131 is described below.

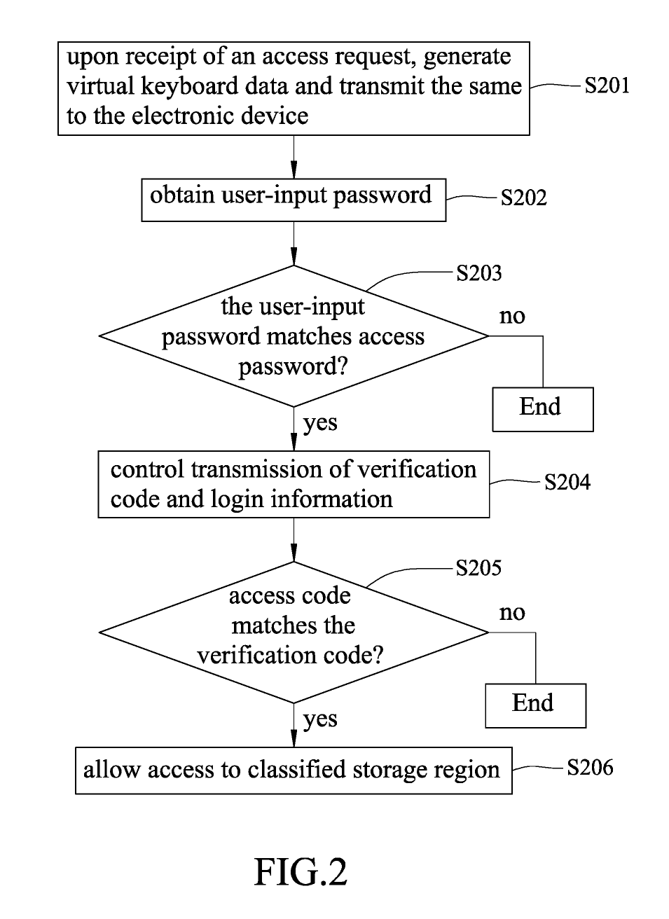

Further referring to FIG. 2, an operation method of the storage device 1 according to one embodiment of this disclosure is provided. In step S201, upon receipt of an access request for accessing the classified storage region 131 from the electronic device 17, the processing module 15 generates virtual keyboard data and transmits the same to the electronic device 17 via the first communication module 11 over the preset communication network 16. In particular, the processing module 15 receives the access request from the electronic device 17 through the first communication module 11 over the preset communication network 16.

In response to receipt of the virtual keyboard data, the electronic device 17 can display a virtual keyboard that includes a plurality of virtual keys arranged in positions different from one another and corresponding respectively to a plurality of characters, and generate input password data in response to user operation on the virtual keyboard. The user of the electronic device 17 can enter a user-input password via the virtual keyboard. The input password data includes position data that is related to the positions of a part of the virtual keys corresponding to the characters composing the user-input password. When the processing module 15 receives the input password data from the electronic device 17 through the first communication module 11 over the preset communication network 16, the flow of the method goes to step S202. In step S202, the processing module 15 obtains the user-input password based on the position data included in the input password data. For example, the processing module 15 generates a correspondence between the position of each of the virtual keys of the virtual keyboard and a corresponding one of the characters as the virtual keyboard data is generated in step S201, and thus the user-input password can be obtained by looking up the correspondence to find the characters that correspond respectively to the virtual keys touched by the user (or the positions thereof).

In step S203, the processing module 15 determines whether the user-input password matches the access password pre-stored in the storage module 13 of the storage device 1 upon receiving the trigger signal that is outputted by the input module 14 in response to the user operation on the input module 14. The flow goes to step S204 when affirmative, and the method is terminated (or alternatively, goes back to step S201) when otherwise. That is to say, the processing module 15 determines whether the user-input password matches the access password only if the trigger signal is received.

In step S204, the processing module 15 generates a verification code, and accesses the login information that is stored in the storage module 13, and controls the first communication module 11 to transmit the verification code and the login information to the electronic device 17 over the preset communication network 16. By this way, the electronic device 17 can communicatively connect the second communication module 12 over the private communication network 18 based on the login information received from the first communication module 11. In response to receipt of the verification code, the electronic device 17 displays the verification code, and the user of the electronic device 17 may input an access code with reference to the verification code di splayed by the electronic device 17, so that the electronic device 17 transmits the access code to the storage device 1 through the private communication network 18. In some embodiments, the access code may be generated by the electronic device 17 based on the verification code. For example, the verification code is a one-time password (OTP) and the present disclosure is not limited in this respect.

In step S205, the processing module 15 determines whether the access code received from the electronic device 17 through the second communication module 12 over the private communication network 18 matches the verification code. The flow of the method goes to step S206 when the determination made in step S205 is affirmative, and the method is terminated (or alternatively, goes back to step S201) when otherwise.

In step S206, the processing module 15 allows the electronic device 17 to access the classified storage region 131 of the storage module 13 via the second communication module 12 over the private communication network 18. Note that, upon allowing the electronic device 17 to access the classified storage region 131 in step S206, the processing module 15 further determines whether the classified storage region 131 has not been accessed for a predetermined time duration (e.g., for five minutes), and prohibits access to the classified storage region 131 when determining that the classified storage region 131 has not been accessed for the predetermined time duration.

To sum up, the processing module 15 is programmed to allow access to the classified storage region 131 upon determining, in response to the user operation on the input module 14, that the user-input password obtained from the electronic device 17 matches the access password pre-stored in the storage device 1, and determining that the access code matches the verification code.

Accordingly, it is relatively difficult for a malicious user/hacker to access data stored in the classified storage region 131. Further, even if the hacker hijacks the input password data to be received by the processing module 15 from the electronic device 17, it is relatively difficult for the hacker to obtain the user-input password since the correspondence between the positions of the virtual keys of the virtual keyboard and the characters are not contained in the user-input data. Additionally, since the preset communication network 16 and the private communication network 18 are both short-range wireless networks, a hacker who is remote from the storage device 1 is not able to connect to either the preset communication network 16 or the private communication network 18 to thereby access data stored in the classified storage region 131 of the storage module 13. That is to say, the electronic device 17 and the storage device 1 should be disposed in an area covered by both the preset communication network 16 and the private communication network 18, and thus unauthorized access to the storage device 13 can be prohibited.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A storage device comprising:
a first communication module configured to be communicatively connected to an electronic device over a preset communication network;
a second communication module configured to provide a private communication network;
a storage module storing an access password, and login information that is for accessing said second communication module over the private communication network, said storage module including a classified storage region; and
a processing module electrically connected to said first communicating module, said second communicating module and said storage module, and programmed to
in response to receipt of input password data from the electronic device via said first communication module over the preset communication network, obtain a user-input password based on the input password data, and determine whether the user-input password matches the access password,
when determining that the user-input password matches the access password, generate a verification code, access the login information stored in said storage module, and control said first communication module to transmit the verification code and the login information to the electronic device via said first communication module over the preset communication network, so that the electronic device communicatively connects said second communication module over the private communication network based on the login information,
in response to receipt of an access code from the electronic device through said second communication module over the private communication network, determine whether the access code matches the verification code, and
when determining that the access code matches the verification code, allow the electronic device to access said classified storage region of said storage module via said second communication module over the private communication network.

2. The storage device as claimed in claim 1, wherein said processing module is further programmed to, upon receipt of an access request for accessing said classified storage region from the electronic device via said first communication module over the preset communication network, generate virtual keyboard data, and control said first communication module to transmit the virtual keyboard data to the electronic device over the preset communication network so as to enable the electronic device to display a virtual keyboard including a plurality of virtual keys arranged in positions different from one another and corresponding respectively to a plurality of characters,
wherein the input password data includes position data related to the positions of a part of the virtual keys that correspond to the characters composing the user-input password, and said processing module is programmed to obtain the user-input password based on the position data.

3. The storage device as claimed in claim 1, wherein said first communication module is a Bluetooth communication module, and said second communication module is a Wi-Fi communication module.

4. The storage device as claimed in claim 1, wherein the login information includes a service set identifier (SSID) and a login password for accessing said second communication module.

5. The storage device as claimed in claim 1, wherein the verification code is a one-time password (OTP).

6. The storage device as claimed in claim 1, further comprising an input module electrically connected to said processing module, and configured to output a trigger signal to said input module in response to a user operation,
wherein said processing module is programmed to determine whether the user-input password matches the access password upon receipt of the trigger signal.

7. The storage device as claimed in claim 1, wherein said processing module is further programmed, by default, to prohibit access to said classified storage region when said storage device is initially powered up.

8. The storage device as claimed in claim 1, wherein said processing module is further programmed to prohibit access to said classified storage region when determining that said classified storage region has not been accessed for a predetermined time duration.

9. An operation method of a storage device, the storage device being communicatively connected to the electronic device over a preset communication network, providing a private communication network, and including a processing module and a classified storing region, the operation method to be implemented by the processing module and comprising:
in response to receipt of input password data from the electronic device over the preset communication network, obtaining a user-input password based on the input password data;
determining whether the user-input password matches an access password that is pre-stored in the storage device;
when determining that the user-input password matches the access password, generating a verification code, accessing login information that is pre-stored in the storage device for accessing the storage device over the private communication network, and transmitting the verification code and the login information to the electronic device over the preset communication network, so that the electronic device communicatively connects the storage device over the private communication network based on the login information;
in response to receipt of an access code from the electronic device through the private communication network, determining whether the access code matches the verification code; and
when determining that the access code matches the verification code, allowing the electronic device to access the classified storage region over the private communication network.

10. The operation method as claimed in claim 9, further comprising:
upon receipt of an access request from the electronic device for accessing said classified storage region over the preset communication network, generating virtual keyboard data and transmitting the virtual keyboard data to the electronic device over the preset communication network so as to enable the electronic device to display a virtual keyboard that includes a plurality of virtual keys arranged in positions different from one another and corresponding respectively to a plurality of characters;
obtaining the user-input password based on position data included in the input password data, the position data related to the positions of a part of the virtual keys that correspond to the characters composing the user-input password.

11. The operation method as claimed in claim 9, wherein the preset communication network is a short-range wireless network using Bluetooth transmission technology, and the private communication network is a wireless local area network using Wi-Fi transmission technology.

12. The operation method as claimed in claim 9, wherein the login information includes a service set identifier (SSID) and a login password for accessing the storage device.

13. The operation method as claimed in claim 9, wherein the verification code is a one-time password (OTP).

14. The operation method as claimed in claim 9, the storage device further including an input module electrically connected to the processing module, the operation method further comprising:
outputting, by the input module and to the processing module, a trigger signal in response to a user operation; and
determining, by the processing module, whether the user-input password matches the access password upon receipt of the trigger signal.

15. The operation method as claimed in claim 9, further comprising prohibiting access to the classified storage region when the storage device is initially powered up.

16. The operation method as claimed in claim 9, further comprising prohibiting access to the classified storage region when determining that the classified storage region has not been accessed for a predetermined time duration.
